(19) United States
(12) Patent Application Publication
(10) Pub. No.: US 2018/0324360 A1
(43) Pub. Date: Nov. 8, 2018

(54) SUPPORT FOR PHOTOGRAPHIC APPARATUSES

(71) Applicant: LINO MANFROTTO + CO. S.P.A., Cassola (IT)

(72) Inventor: Gabriele GABRIELLI, Pove Del Grappa (IT)

(21) Appl. No.: 16/033,049

(22) Filed: Jul. 11, 2018

Related U.S. Application Data
(63) Continuation-in-part of application No. 14/894,521, filed on Nov. 28, 2015, now abandoned.

(30) Foreign Application Priority Data
May 31, 2013 (IT) PD2013A000154

(51) Int. Cl. H04N 5/232; F16M 11/28

(52) U.S. Cl. CPC H04N 5/23299; F16M 2200/027; F16M 11/28

(57) ABSTRACT

A support (1) for video-photographic apparatus (1) comprises a cross-member (2) which defines a hole (5), a column (6) having a shaft (21) which is slidable in the hole (5) along a longitudinal axis (Z), a plate (7) which is provided with an engaging device (8) for engaging a piece of video-photographic apparatus with that plate (7) and a sleeve (10) which is internally hollow, which extends along a longitudinal axis (Z) and which is capable of receiving an engaging portion (23) of the column (6), the plate (7) further comprising a locking device (13, 18, 25, 26, 10c) which can be removed in order to fix the engaging portion (23) of the column (6) to the sleeve (10).

### CROSS REFERENCE TO RELATED APPLICATION

This application is a continuation-in-part of U.S. application Ser. No. 14/894,521, filed on Nov. 28, 2015, which is a U.S. National Stage Application of PCT/EP2014/061156 filed on May 28, 2014, which claims priority to Italian patent application PD2013A000154 filed on May 31, 2013, the contents of each of which are hereby incorporated herein by reference in their entirety.

### FIELD OF THE INVENTION

The present invention relates to a support for video-photographic apparatuses and the like.

### BACKGROUND

In the field of photography, television and cinematography, it is widely known to use supports, such as tripods, stands or the like, for supporting the recording apparatuses in an orientable manner.

In such a technical field, the supports set out comprise a cross-member to which there are connected in known manner three or more telescopic legs and a column which is axially slidable inside a hole defined in the cross-member.

At one end of the column there is mounted a plate which is intended to receive the apparatus to be supported.

The legs are usually telescopic and can be positioned and locked at different opening angles with respect to the cross-member, while the axial sliding of the column inside the hole of the cross-member allows variation in the height of the plate and therefore of the apparatus which is engaged therewith in order to carry out recordings of subjects positioned at different heights.

A disadvantage of the known supports is constituted by the interference between the column portion projecting below the cross-member and the support surfaces of the support which prevent positioning of the video-photographic apparatus in a very low position, for example, for carrying out recordings at levels close to the ground.

That disadvantage is overcome by the support described in WO2007/125082 in the name of the same Applicant.

The support of WO2007/125082 comprises a cross-member to which there are hinged the support legs of the tripod, a column which can slide in a hole provided in the cross-member and which is provided at an end thereof with a plate which is intended to receive a video-photographic apparatus and at an opposite end thereof with a cap. The plate and the cap are fixed to the column with a removable fixing mechanism so as to be able to be disengaged from the column and fixed at opposite ends of the cross-member.

When it is desirable to limit the vertical spatial requirement of the support, for example, in order to photograph subjects positioned on or near the ground, the operator provides for the separation of the cap and the plate from the column, for removal of the column from the hole of the cross-member and subsequently for the engagement of the plate and the cap directly on the cross-member.

Though that support solves the above-mentioned problem, it has the disadvantage that the operations necessary for converting the support from the configuration with a column to the short configuration, or the configuration without a column, are slightly long and laborious.

In order to carry out the above-mentioned conversion, it is necessary to separate the plate to which the head is fixed and therefore the video-photographic apparatus, from the column and, after having unscrewed the column from the hole, to re-engage the plate directly on the cross-member.

Therefore, there is the risk of damaging the head and the video-photographic apparatus.

### BRIEF SUMMARY OF THE INVENTION

The problem addressed by the present invention is to provide a support for video-photographic apparatus, which support is structurally and functionally intended to overcome the limitations set out above.

This problem and other problems which will be appreciated more clearly below are considered and solved by the invention by a support produced in accordance herewith.

According to an aspect of the invention, provided herein are supports for video-photographic apparatuses comprising: a cross-member, which defines a hole, a column having a shaft, the shaft being slidable in the hole along a longitudinal axis, a plate provided with an engaging device for engaging a piece of video-photographic apparatus with the plate, a sleeve that is internally hollow and extends along the longitudinal axis and which is capable of receiving an engaging portion of the column, the sleeve being supported in a fixed manner to the plate, a locking device for removably locking the sleeve to the engaging portion of the column, wherein the sleeve comprises a tubular cylindrical body extending along the longitudinal axis when the sleeve is locked to the engaging portion, the tubular cylindrical body having an outer diameter that is substantially equivalent to an outer diameter of the shaft so that the sleeve is also slidable in the hole, wherein the cross-member comprises a clamp element configured for either clamping the column with the sleeve locked to the engaging portion on the cross-member, or clamping the sleeve alone when inserted in the hole with the column removed.

Advantageously the locking device comprises a locking ring nut that engages on a thread formed along the longitudinal axis, the locking ring nut urging on locking elements when screwed on the thread so as to move resiliently them along a radial direction through openings provided on to engage them with the engaging portion of the column.

### BRIEF DESCRIPTION OF THE SEVERAL VIEWS OF THE DRAWINGS

The features and advantages of the invention will be appreciated more clearly from the detailed description of a preferred though non-exclusive embodiment thereof which is illustrated by way of non-limiting example with reference to the appended drawings, in which:

FIG. 1 is an exploded, broken-away and partially sectioned view of the support of the invention;

FIG. 2 is a broken-away and partially sectioned front view of the support according to the invention in a first operative configuration W;

FIG. 3 is a view similar to that of FIG. 2 but in relation to an intermediate configuration W′;

FIGS. 4 and 5 are cross sections, taken respectively, along plane IV-IV of FIG. 2 and along plane V-V of FIG. 3 of the support corresponding to the views of FIGS. 2 and 3, respectively;

FIG. 6 is a view similar to FIG. 2 but in relation to a second operative configuration W″;

FIG. 7 is a view of a detail of the support of the invention with some parts removed for clarity sake;

FIGS. 8 and 9 are exploded view of some elements of the support of the invention in vertical section taken from different angulations;

FIG. 10 is a view of a detail of the support of the invention with some parts removed for clarity sake;

FIG. 11 is an enlarged view of a particular of FIG. 2;

FIG. 12 is an enlarged view of a particular of FIG. 1;

FIG. 13 is an enlarged view of FIG. 1; and

FIG. 14 is a broken-away and partially sectioned front view of the support according to the invention in a further operative configuration W.

### DETAILED DESCRIPTION OF THE INVENTION

The Figures show a support tripod 1 for video-photographic apparatuses, which support is constructed in accordance with the present invention.

The tripod 1 comprises a cross-member 2 which is formed so as to define three hinging extension pieces 3, in the region of each of which a support leg 4 is hinged.

The support legs 4 can be telescopically adjusted in terms of length in a manner which is known per se so as to vary the height of the tripod and/or the spatial requirement thereof.

The cross-member 2 is formed so as to define a sliding hole 5 which is intended to receive in sliding engagement a column 6 of the tripod 1. The column 6 can slide in the hole 5 along a longitudinal axis Z of the same hole 5.

The sliding hole 5 is so configured to receive in sliding engagement a sleeve 10 of a plate 7, as will be better explained in the following. Plate 7 refers to the apparatus that includes, inter alia, a coupling portion 9, hollow sleeve 10, and resting plate 70, as discussed further herein.

The cross-member 2 further comprises a clamp ring 20 which can be actuated by a user of the tripod 1 to unlock/lock the movement along the axis Z of the column 6 and/or the sleeve 10 in a manner which is known per se in the sector.

The clamp ring 20 is screwed on a threaded surface of the cross-member 2 so as to be rotated about the cross-member 2.

The cross-member 2 is further provided with a fitting cone 200 internally hollow and delimited by an internal surface 201 defining the hole 5 of the cross-member 2.

The internal surface 201 of the fitting cone is tapered along the longitudinal axis Z so that moving the fitting cone 200 along the longitudinal axis Z the pressure applied by the fitting cone 200 on the column 6 or on the sleeve 10 is changed and the column 6 or the sleeve 10 is clamped in the hole 5 or released from the hole 5 and may be moved along the longitudinal axis Z, as will be better explained in the following.

The fitting cone 200 is provided with a recess 202 in which a protrusion 20′ of the clamp ring 20 is housed in a sliding manner, so that the clamp ring 20 is rotatable about the fitting cone 200.

The fitting cone 200 may be made of plastic material in example embodiments.

The tripod 1 further comprises a plate 7 (or plate apparatus 7), which is provided with a resting plate 70 on which a piece of video-photographic apparatus (not illustrated in the Figures) is positionable, an engagement device, for example, an engaging screw 8 of substantially cylindrical form and coaxial with respect to the longitudinal axis Z in order to engage the piece of video-photographic apparatus (not illustrated in the Figures) with the plate 7.

The resting plate 70 further comprises an abutment surface S which is intended to receive in abutment the video-photographic apparatus.

The plate 7 comprises a coupling portion 9 from which an internally hollow sleeve 10 projects. The sleeve 10 extends from the coupling portion 9 of the plate 7 in a direction opposite to the resting plate 70.

The sleeve 10 and the coupling portion 9 are fixedly coupled to the resting plate 70, advantageously, the sleeve 10 and the coupling portion 9 are integral with the resting plate 70. Advantageously, the sleeve 10 and the coupling portion 9 are integral one with another.

The sleeve 10 extends along a longitudinal axis which, during use of the tripod 1, or with the sleeve 10 fixed to the column 6 or the hole 5 itself, substantially corresponds to the longitudinal axis Z of the hole 5. Therefore, the above-mentioned axes will be indicated below with the same reference numeral for the sake of brevity.

The sleeve 10 comprises a tubular cylindrical body extending along longitudinal axis which, during use, substantially corresponds to the longitudinal axis Z of the hole 5.

The sleeve 10 is formed so as to slidingly receive the column 6 in order to couple the column 6 to the plate 7, as will be better explained below.

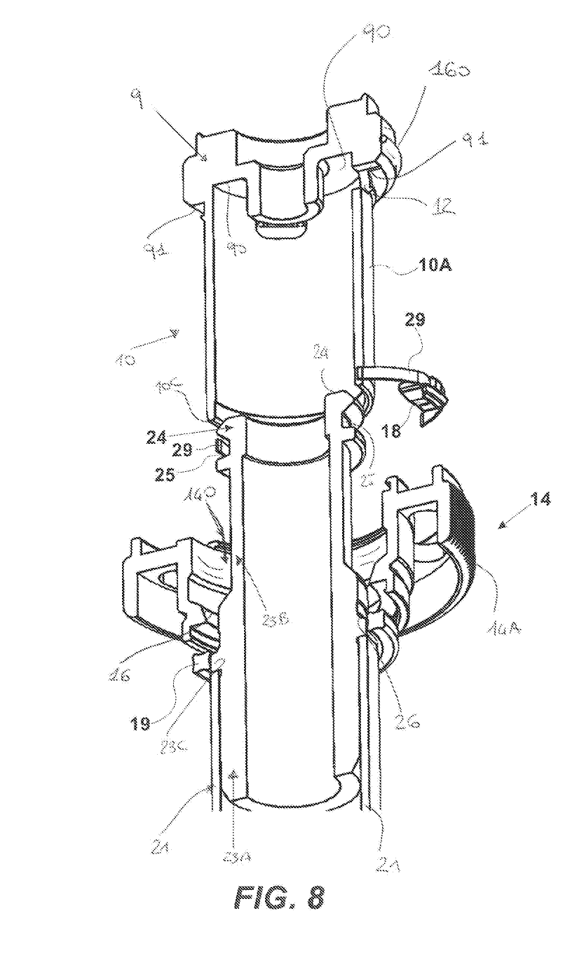

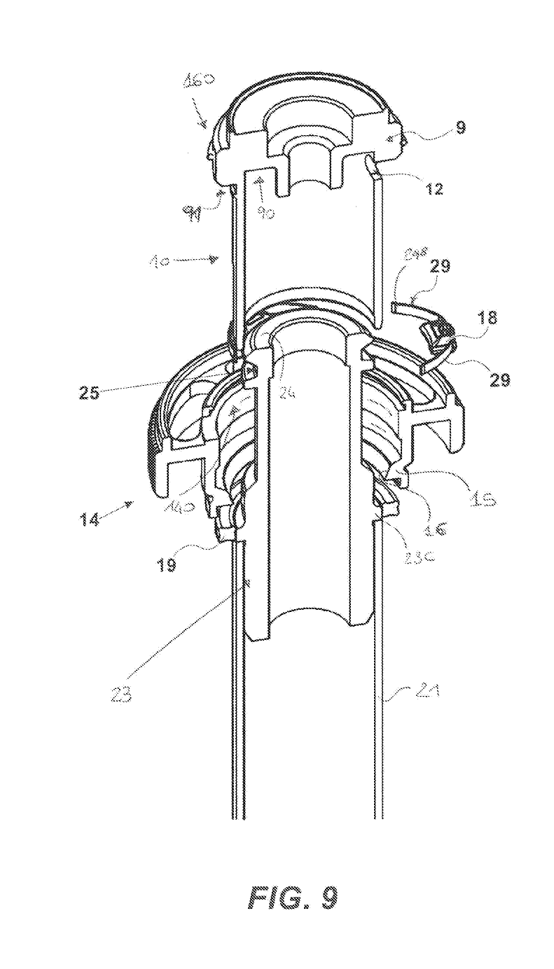

The sleeve 10 is provided on the external surface 10A thereof with a plurality of circumferentially spaced holes 12 which may be seen better in FIGS. 8 and 9.

In the version shown there are provided three holes 12 on the external surface 10A which are spaced apart by an angle of approximately 120°.

The holes 12 are formed so as to cooperate with a locking device 13 which is provided in the plate 7 and which is arranged to lock/unlock the column 6 in/from the sleeve 10, in order to couple/uncouple the plate 7 and the column 6, as will be better explained below.

The plate 7 includes, inter alia, a locking device 13 arranged in a portion of the plate proximal to the resting plate 70 and arranged for interacting with a portion of the column positioned proximally to the resting plate 70 when the column is inserted into the sleeve 10 for locking the column to the sleeve 10 and then to the plate 7. The plate 7 is further provided with a coupling device defined in the sleeve 10 and arranged at a portion of the latter positioned distally from the resting plate 70 and arranged for engaging the column 6 at a portion thereof positioned distally from the resting plate 70.

In this way, owing to the locking device and the coupling device, the column 6 and the plate 7 are mutually coupled into two different positions spaced along the longitudinal axis of the column 6.

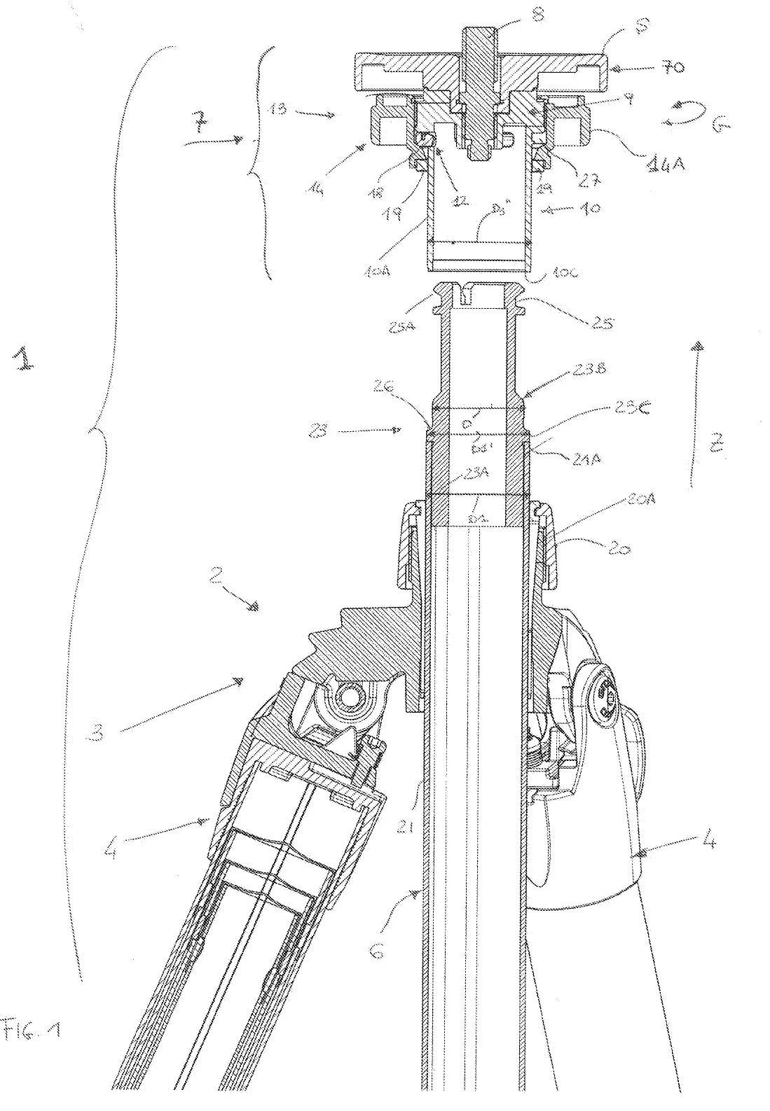

The locking device 13 comprises a locking ring nut 14 which is arranged externally with respect to the coupling portion 9 and which is capable of being rotated, in both directions of the arrow G in FIG. 1, by a user of the tripod in order to lock/unlock the column 6 in/from the sleeve 10. The locking ring nut 14 is arranged externally with respect to the sleeve 10, so that a housing 27 is defined therebetween.

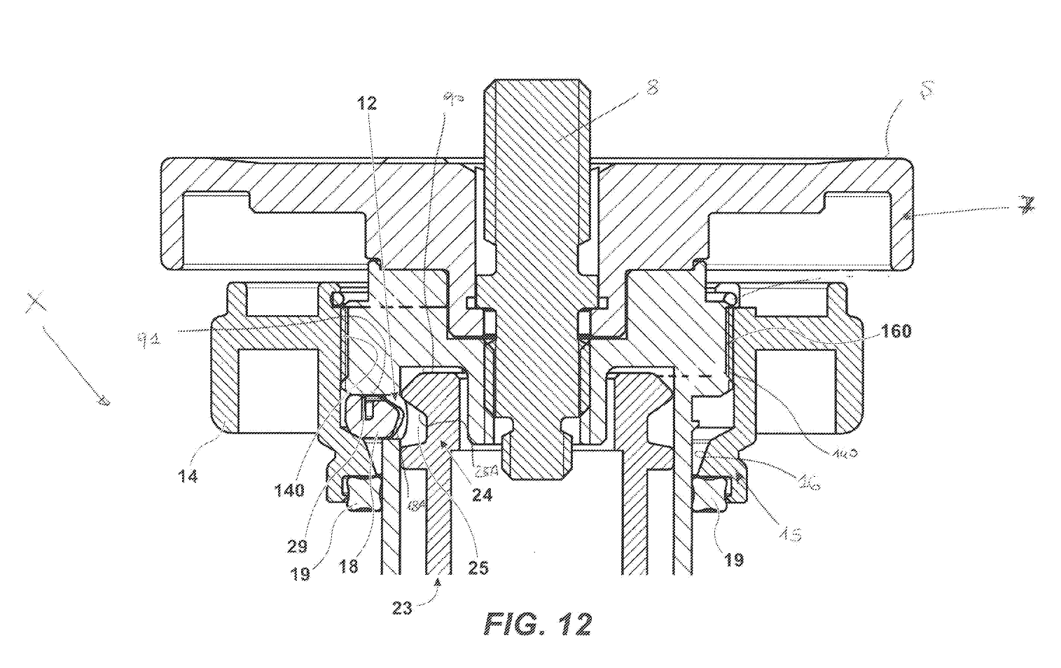

The locking ring nut 14 and the coupling portion 9 are provided on mutually facing surfaces with corresponding threads indicated respectively with 140 and 160, shown in greater detail in FIGS. 8, 9, 11 and 12 and arranged for allowing the rotation of the locking ring nut 14 on the coupling portion 9 about the longitudinal axis Z.

Rotating the locking ring nut 14 in both directions of the arrow G around the thread 140, the locking ring nut 14 is moved towards and away from the resting plate 70, as better disclosed in the followings.

Rotating the locking ring nut 14, the latter is also moved in relation to the coupling portion 9 and to the sleeve 10 in the longitudinal direction Z.

The locking device 13 further comprises a plurality of locking elements or locking blocks 18 which can be moved by the locking ring nut 14 in order to lock/unlock the column 6 in/from the sleeve 10.

In the present description the term “block” is not limited to a particular shape, such as a cubical or square shape, but rather is intended to encompass any suitable shape. That is, the present application does not limit the shape of the fixing elements 18 to square or cubical shapes despite the use of the term “blocks” in reference to certain embodiments of this element. Even elements with inclined surface may be indicated as locking blocks.

In further versions not shown, the support 1 is provided with a locking device 13 different from the ring nut and suitable for moving locking blocks, or different suitable locking elements, in order to lock/unlock the column 6 into/from the sleeve 10. As a locking device 13 could for example be used an eccentric lever, a knob, a screw, etc.

The locking blocks 18 are provided in a number corresponding to the holes 12 of the sleeve 10 and each locking block 18 of the plurality of locking blocks is formed so as to be able to be received in a sliding manner in a corresponding hole 12, as will be explained in greater detail in the followings.

The locking block 18 is so shaped that they can be received in a sliding manner in a corresponding hole 12 so as to lock/unlock the column 6 into/from the sleeve 10 when the column 6 is inserted into the sleeve 10, as disclosed herein.

In the version shown, there are provided three locking blocks 18 positioned circumferentially equidistant in a position corresponding to the position of the holes 12.

In other embodiments, a different number of holes and of corresponding locking blocks could be provided in the sleeve 10.

Each locking block 18 is produced from metal material, for example, Zamak alloy.

In other versions (not shown) of the tripod 1, there may be provided a different number of locking blocks, which are preferably equidistant.

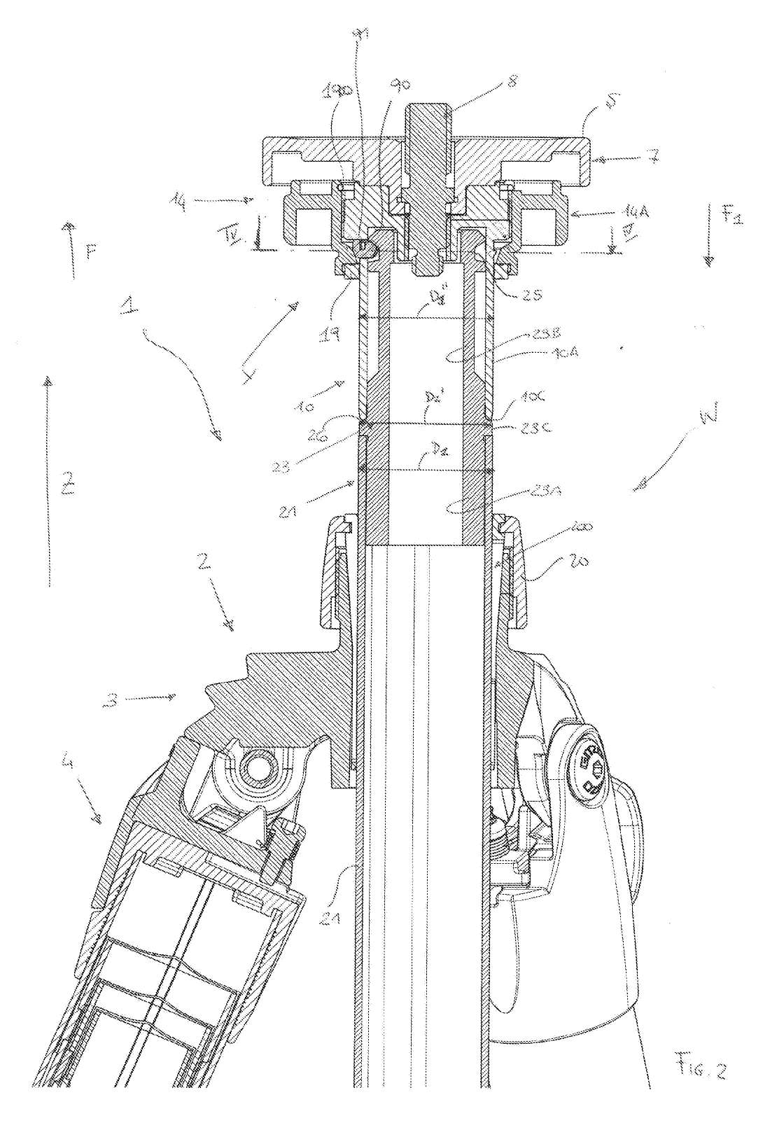

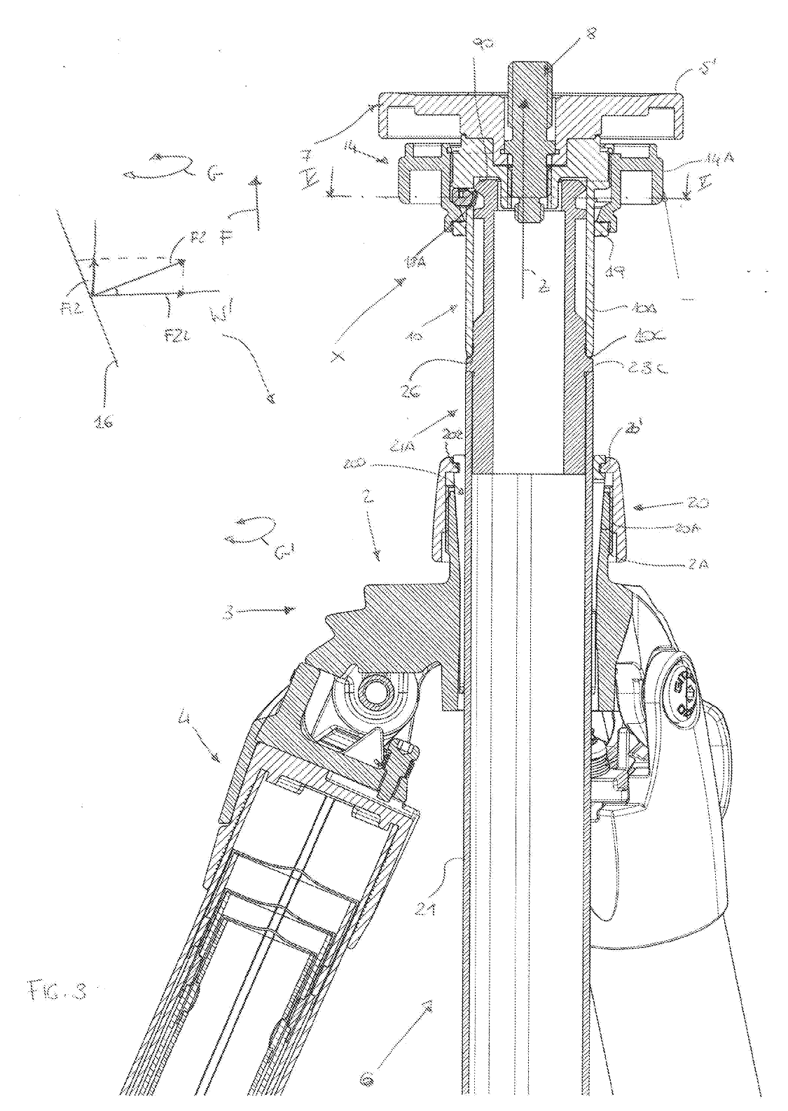

The locking blocks 18 are movable between a retracted configuration X, which is shown in FIGS. 3, 5, 10 and 12 and in which the locking blocks 18 are positioned in the housing 27 which is defined between the locking ring nut 14 and the sleeve 10 and in which configuration the column 6 can be moved with respect to the sleeve 10 and a locking configuration Y, which is shown in FIGS. 2, 4, 7 and 11 and in which each block 18 is inserted in the corresponding hole 12, thereby projecting inside the sleeve 10 and interfering with the column 6, locking it in the sleeve 10, as will be better explained below.

In the retracted configuration X, the locking blocks 18 are housed in the housing 27 and spaced apart from the column 6, so that the column can be moved longitudinally into the sleeve 10.

On the contrary, in the locking configuration Y the locking blocks 18 are inserted in the holes 12 and protrudes from the holes 12 towards the column 6 and interfere with column 6 locking it in relation to the sleeve 10. In the locking configuration Y, the locking blocks 18 constitute locking elements 18 of the locking device 13 which cooperate with corresponding counter locking elements provided on the column 6 in order to lock that column in the sleeve 10.

The locking device 13 further comprises a pushing device which is associated with the locking blocks 18 and which is arranged to push them inside the housing 27 so that they do not interfere with the column 6. The pushing device is configured to push the locking blocks 18 in the retracted configuration X.

In the version shown, the pushing device comprises three flat springs 29, each flat spring 29 being associated with a corresponding locking block 18 and being arranged so as to apply to each locking block 18 a pushing force which is capable of pushing the locking block 18 into the housing 27.

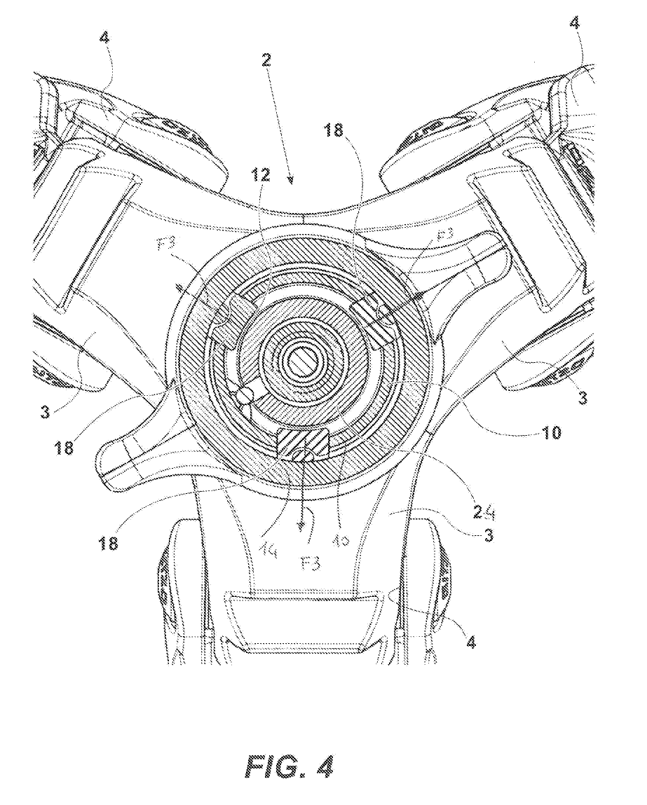

The flat springs 29 are arranged for applying a force indicated with the arrow F3 in FIG. 4 directed for moving the locking blocks 18 into the housing 27, i.e. away from the column 6.

The force F3 exerted by the flat springs 29 is directed radially.

The flat springs 29 are lamina springs.

Each flat spring 29 comprises a central part 29A and two opposing ends 29B. Each flat spring 29 deformed to be coupled to the locking block bending the central part 29A thereof to form a “W” shaped element with the two opposing ends 29B projecting from the central part 29A in diverging directions.

The central part 29A is inserted in the housing groove 180, whilst the two opposing ends 29B abuts against the external surface 10A of the sleeve 10. The surface of the sleeve 10 exerts a force on the ends 29B which is transmitted on the central part 29A. The latter exerts a force on the locking block 18 so directed to move the locking blocks 18 into the housing 27.

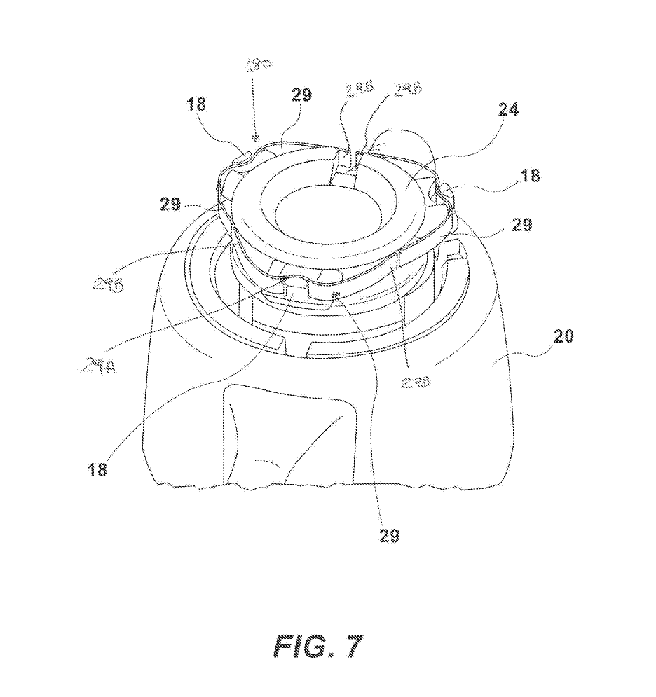

The flat springs 29 are independent one from another as shown for example in FIG. 7. FIG. 7 is a view of a detail of the support of the invention with some parts removed for clarity sake. By way of non-limiting example, in FIG. 7, the sleeve 10 is not depicted so that other elements may be more clearly seen, but it should be understood that such elements remain present in the device.

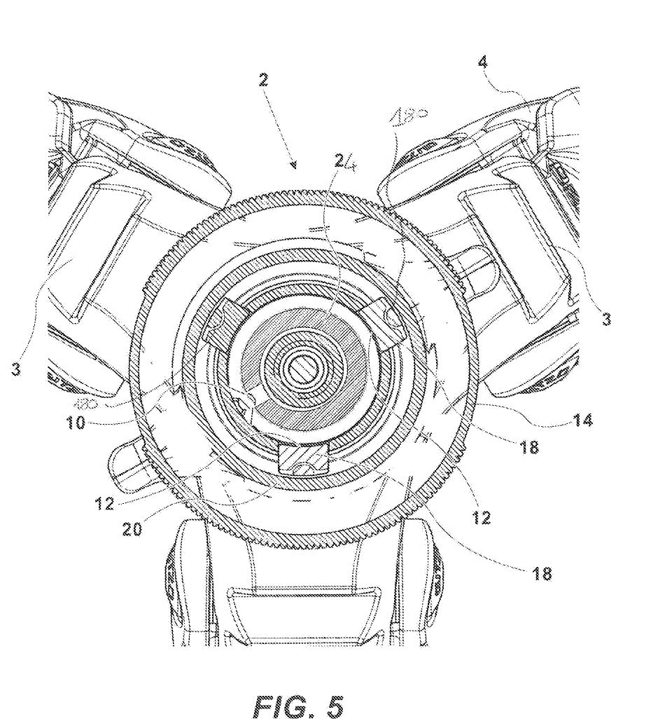

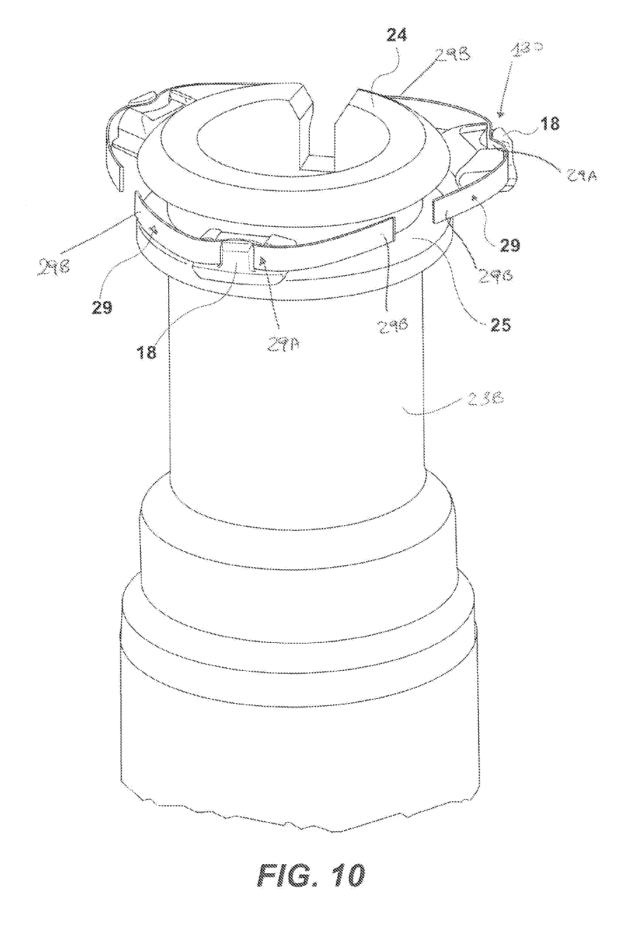

Additionally, some elements are not depicted in FIG. 10 for clarity sake (including e.g. the sleeve 10), but should be understood as being present. Each locking block 18 is provided with a housing groove 180, better visible in FIGS. 5 and 7, in which a corresponding flat spring 29 is housed.

The housing groove 180 is “U” shaped and closed in the direction of the movement of the locking block 18 so that there is no movement of the flat spring 29 from the housing groove 180 in the movement of the locking block 18.

This will avoid any unwanted movement of the flat spring 29 from the housing groove 180.

In other versions which are not shown, there may be provided a pushing device which is different from the flat springs, or can be provided a single flat spring pushing all the locking blocks 18.

The locking ring nut 14 comprises a handle portion 14A which is capable of being gripped by the user in order to rotate the locking nut 14 from which there extends, at the opposite side of the resting plate 70, an actuation extension piece 15 which is arranged circumferentially externally with respect to the sleeve 10.

The actuation extension piece 15 comprises a pushing surface 16 which is arranged in an inclined direction with respect to the longitudinal axis Z of the sleeve 10 and which is capable of receiving in abutment the locking blocks 18 so that the locking blocks 18 can slide with respect to the pushing surface 16. The pushing surface 16 is preferably arranged at an angle α between 15° and 30° with respect to the longitudinal axis Z of the sleeve 10 so as to constitute a sliding cone for the locking blocks 18.

The pushing surface 16 is arranged so as to converge towards the sleeve 10 in a direction away from the locking ring nut 14 so that the pressure applied by the pushing surface 16 to the locking blocks 18 increases in a direction away from the locking nut 14, or in the direction of the arrow F2, as will be better explained below.

Since the pushing surface 16 is inclined with respect to the longitudinal axis Z, moving it along the longitudinal axis Z varies the pressure applied by the pushing surface 16 to the locking blocks 18, as will be better explained below.

In particular, because pushing surface 16 converges towards the sleeve 10 in a direction away from the locking ring nut 14, moving the locking ring nut 14 towards the resting plate 70, the force exerted by the pushing surface 16 on the locking blocks 18 is increased and viceversa moving the locking ring nut 14 away from the resting plate 70, the force exerted by the pushing surface 16 on the locking blocks 18 is decreased.

By rotating the locking ring nut 14 around the coupling portion 9 the locking ring nut 14 is moved along the longitudinal axis Z, the pushing surface 16 is consequently moved along the longitudinal axis Z.

By moving the pushing surface 16 along the longitudinal axis Z the force applied by the pushing surface 16 to the locking blocks 18 is changed.

The pushing surface 16 which is inclined with respect to the longitudinal axis Z and arranged for receiving in slidable abutment the locking blocks 18 could be provided also with a locking device different form the locking ring nut, in particular not necessarily with rotational locking device.

By the locking ring nut 14 being rotated about the sleeve 10, the ring nut 14 is moved, in accordance with the direction of rotation, in translation along the longitudinal axis Z towards/away from the resting plate 70, a rototranslational movement of the locking ring nut 14 is thus obtained.

When the ring nut 14 is moved towards the resting plate 70, the pushing surface 16 which is fixedly joined to the ring nut 14 is also moved towards the resting plate 70, sliding with respect to the locking blocks 18.

Since, as mentioned, the pushing surface 16 is inclined with respect to the longitudinal axis Z, the translation movement of the pushing surface 16 towards the resting plate 70 causes there to be applied an increasing pushing force to the locking blocks 18.

The pushing force applied by the pushing surface 16 to the locking blocks 18, which force is indicated by the arrow F2 in FIG. 3, is directed in a direction different from the direction along which the pressure applied by the flat springs 29 to the locking blocks 18 acts.

By progressively moving the pushing surface 16 towards the resting plate 70 the pushing force applied by the pushing surface 16 to the locking blocks 18 is gradually increased, when the pushing force is greater than the force applied by the flat springs 29 the force exerted by the flat springs 29 is overcome and the locking blocks 18 are moved from the retracted configuration X towards the locking configuration Y.

Therefore, rotating the ring nut 14 so as to move is towards the resting plate 70 the locking blocks 18 are progressively pushed towards the column 6 into the holes 12.

Therefore, the locking blocks 18 slide on the pushing surface 16 and are pushed towards the holes 12 and progressively removed from the housing 27 and inserted inside the respective holes 12 provided in the sleeve 10 until they are moved into the locking configuration Y in which the locking blocks 18 project inside the sleeve 10 so as to lock the column 6 in the sleeve 10, as will be better explained below.

Conversely, when the ring nut 14 is rotated in the direction of rotation so as to cause the ring nut 14 to move away from the resting plate 70, the pushing surface 16 moves in translation away from the resting plate 70, slides with respect to the locking blocks 18, causing a relative movement between the locking blocks 18 and the pushing surfaces 16 so as to reduce the interference between the pushing surface and the locking blocks 18.

The pushing force exerted by the pushing surfaces 16 on the locking blocks 18 is gradually reduced and the locking blocks 18 may be moved in response to the force exerted by the springs 29.

When the pushing surface 16 is moved in translation away from the resting plate 70 the interference between the pushing surface 16 and the locking blocks 18 is reduced so that the locking blocks 18 are moved in reaction to the force F3 exerted by the flat springs 29 towards the housing 27.

Since the pushing surface 16 is inclined with respect to the longitudinal axis Z, the force applied by the pushing surface 16 to the locking blocks 18 progressively decreases, moving the pushing surface 16 in translation away from the resting plate 70.

The locking blocks 18 remain attached to the pushing surface 16 owing to the effect of the pressure applied by the flat springs 29, and they are discharged from the respective holes 12 and are progressively received in the housing 27, so as to unlock the column 6 with respect to the sleeve 10, until the retracted configuration X is reached, as will be better explained below.

The flat springs 29 allow the locking blocks 18 to be pushed and retained in the housing 27.

The flat springs 29 push the locking blocks 18 against the pushing surface 16.

Conversely, because the pushing surface 16 is inclined with respect to the longitudinal axis Z, the force applied by the pushing surface 16 to the locking blocks 18 progressively increases, by moving the pushing surface 16 in translation towards the resting plate 70.

Therefore, the force exerted by the flat springs 29 is progressively overcome until the locking blocks 18 are moved by the pushing surface 16 towards the holes 12 and the column 6.

The locking ring nut 14 further comprises a gasket 19 which is arranged circumferentially on the sleeve 10 and which is arranged to abut the clamp ring 20 of the cross-member 2 when the plate 7 is slide towards the clamp ring 20.

The gasket 9 may be made of an elastic material so that the gasket could act as shock absorbing element.

The column 6 comprises a shaft 21 which is of tubular form and which extends longitudinally along a longitudinal axis of the column 6, that longitudinal axis, during use of the tripod 1 or with the column 6 inserted in the hole 5, substantially corresponds to the longitudinal axis Z of the hole 5, and therefore the above-mentioned axes will be indicated with the same reference numeral below for the sake of brevity.

The shaft 21 is so configured as to be able to slide inside the hole 5 and is provided at a longitudinal end 21a thereof with an engagement portion which is capable of being inserted in the sleeve 10 in order to connect the column 6 to the plate 7, as discussed herein.

The engagement portion is integral with the shaft 21.

The engagement portion is formed in the manner of a neck 23 comprising a first portion 23A which is positioned inside the shaft 21 and which is fixed thereto, a second portion 23B which is capable of being inserted in a sliding manner inside the sleeve 10 and a shoulder 23C which is interposed between the first portion 23A and the second portion 23B and which is capable of acting as a travel limit element during the insertion of the neck 23 in the sleeve 10.

The first portion 23A, the second portion 23B and the shoulder 23C are integrally formed.

The shoulder 23C has an outer diameter D1′, the shaft 21 has an outer diameter D1 and the sleeve 10 has an outer diameter D1″.

D is the external diameter of the portion 23B, i.e., a portion having a diameter less than the diameter of the shoulder 23C.

In the version shown, the shoulder 23C, the shaft 21 and the sleeve 10 have the same value of the respective outer diameter D1′, D1, D1″ so that, with the column 6 fixed to the sleeve 10, there is substantially produced a continuous surface and, therefore, the assembly comprising the column 6 and plate 7 can slide freely along the longitudinal axis Z of the hole 5 and both the column 6 and the sleeve 10 can be similarly fixed in the hole 5 of the cross-member 2.

Also the sleeve 10 can slide freely along the longitudinal axis Z of the hole 5 either when the column 6 is locked thereto and also when the column 6 is removed from the sleeve 10.

By actuating the clamp ring 20 either the column 6 or the sleeve 10 may be clamped in the hole 5.

In further versions not shown, the sleeve 10 has an outer diameter D1″ which is substantially equivalent to the outer diameter D1 of the shaft 21 of the column 6. The difference between the value of the outer diameter D1″ of the sleeve 10 and the outer diameter D1 of the shaft 21, is comprised preferably between 5-10% of the outer diameter D1″ of the sleeve 10.

As mentioned before, in a particularly advantageous version, the sleeve 10 and the shaft 21 have the same value of their outer diameter D1, D1″.

The column 6 can slide in the hole 5, along the longitudinal axis Z, so as to vary the spacing between the resting plate 70 and the cross-member 2, or the spatial requirement of the tripod 1 and/or the positioning height of the video-photographic apparatus engaged on the resting plate 70.

The second portion 23B of the neck 23 has an outer diameter less than the outer diameter D1′ of the shoulder 23C so as to be able to be inserted in the sleeve 10 and to be able to slide inside the sleeve 10.

At the mouth 24 of the second portion 23B, i.e. at the opposite side with respect to the shoulder 23C, the second portion 23B is provided with a groove 25 which extends circumferentially at the mouth 24 and which is formed so as to constitute the counter locking device which are capable of cooperating with the locking device of the plate 7 in order to lock the column 6 in the sleeve 10.

The groove 25 is formed so as to be connected in a positive-locking manner to the locking blocks 18 of the plate 7 in order to lock the column 6 in the sleeve 10. In the locking position Y, the locking blocks 18 are received in the groove 25, pushed by the pushing surface 16.

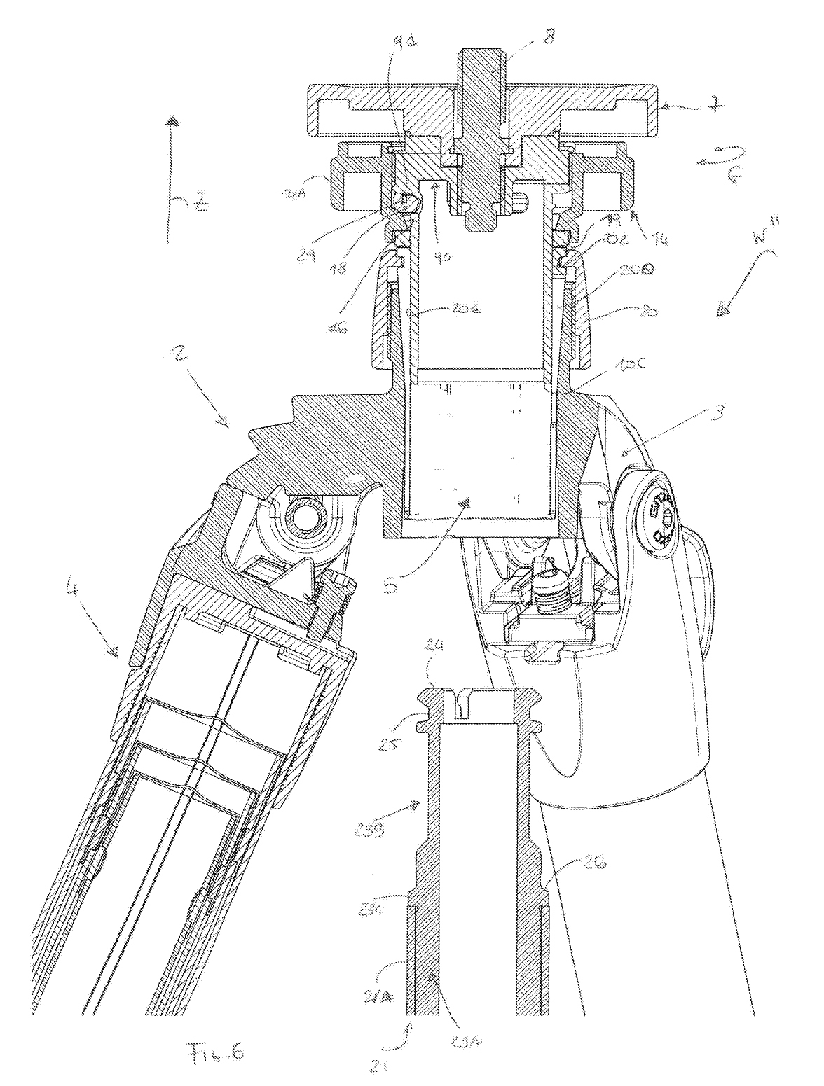

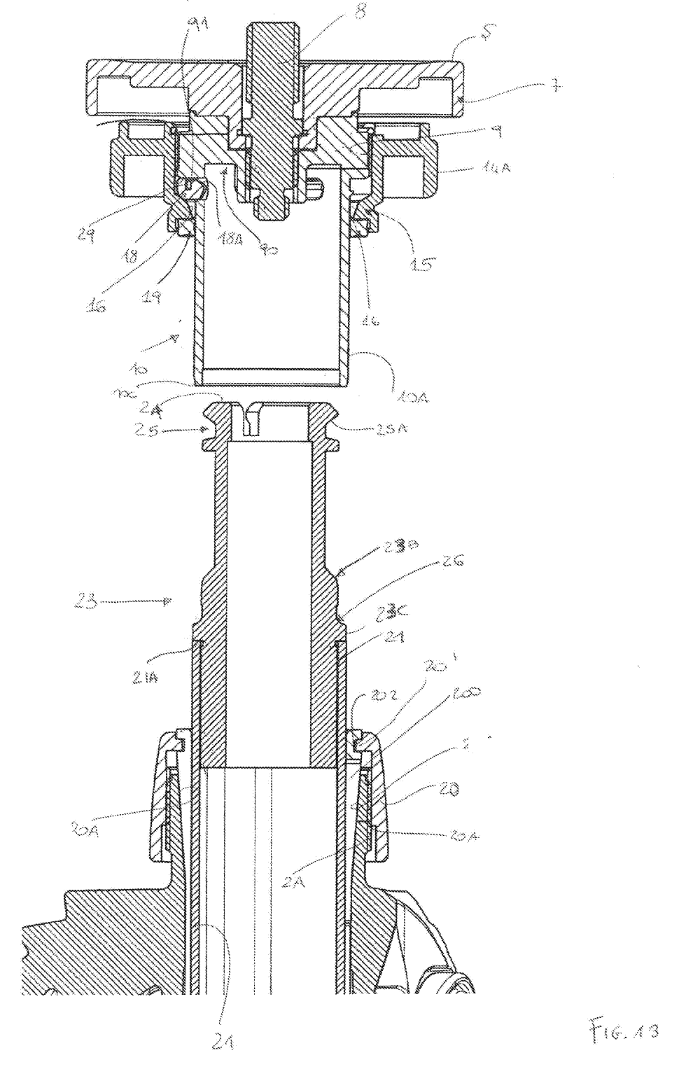

The surface 26 of the shoulder 23C which is better visible in FIGS. 6 and 13 and which is directed towards the second portion 23B is formed so as to constitute a locking element for the column 6 in the sleeve 10. The surface 26 is capable of cooperating with the free edge 10C of the sleeve 10 in order to lock the column 6 in the sleeve 10.

The surface 26 is further capable of acting as a travel limit element for the sliding of the column 6 in the sleeve 10, as will be better explained below.

The free end 10C and the surface 26 are formed so as to constitute an engaging (or fixing or coupling) device and a counter engaging (or fixing or coupling) device which mutually cooperate in order to lock the column 6 in the sleeve 10, respectively.

The surface 26 is in the form of a spherical radius whilst the free edge 10C is of conical form, and therefore there is produced between the surface 26 and the free edge 10C a linear contact which is capable of locking the column 6 in the sleeve 10.

In use the surface 26 of the shoulder 23C matches with the free edge 10C of the sleeve 10 forming a positive coupling.

Therefore, the sleeve 10 is provided with first and second locking devices (or locking elements) which are provided in longitudinally opposing positions and which cooperate with corresponding first and second counter locking devices (or counter-locking elements) of the engaging portion 23 of the column 6 which are also provided at longitudinally opposing positions. The second locking device/element engage one another as described herein to help prevent movement between the shaft and the column 6, and therefore may also be considered coupling devices and counter coupling devices, second fixing and second counter fixing devices or elements, or second engating and second counter engaging devices or elements.

Therefore, the engaging portion of the column, i.e. the neck 23 and the sleeve 10 are mutually locked (or fixed or engaged) in the region of the two opposing longitudinal ends thereof.

This substantially improves the relative locking action between the neck 23 and, therefore the column 6, and the plate 7, preventing play and oscillations about the longitudinal axis Z.

This improves the positioning of a piece of video-photographic apparatus which is engaged with the resting plate 70 and the quality of the exposures taken.

When a user wishes to use the tripod 1 in the operative configuration W shown in FIG. 2, i.e. with the column 6, he provides for the shaft 21 of the column 6 to be introduced into the hole 5 and the neck 23 in the sleeve 10 of the plate 7 by moving the free end 24 towards a lower base 90 of the coupling portion 9, so as to configure the tripod 1 in the intermediate operative configuration W′ of FIG. 3.

In the intermediate operative configuration W′, the locking blocks 18 are inserted in the housing 27 and the neck 23 can slide in the sleeve 10.

The locking nut 14 is completely opened, i.e. rotated as far as the travel limit furthest from the surface S of the resting plate 70.

As can be clearly seen in FIG. 3, in this position the sleeve 10 is interposed between the neck 23 and the locking nut 14.

Subsequently, the user provides for locking the column 6 and the plate 7 by moving the tripod into the first operative configuration W of FIG. 2.

In order to do this, the user rotates the locking nut 14 about the longitudinal axis Z in such a direction as to cause the locking ring nut 14 to move towards the surface S of the resting plate 70.

That rotation causes a movement of the pushing surface 16 towards the resting plate 70, as indicated by the arrow F in FIGS. 2 and 3, which in turn applies a progressively increasing pushing force to the locking blocks 18 in the direction orthogonal to the pushing surface 16, as shown by the arrow F2 in FIG. 3.

The pushing surface 16 is inclined with respect to the longitudinal axis Z, progressively moving the pushing surface 16 towards the resting plate 70, the locking blocks 18 would be gradually urged towards the resting plate 70 by the effect of the component F₁₂ of the pushing force F2 and towards the interior of the sleeve 10 by the effect of the component F₂₂ of the pushing force F2.

No movement of the locking blocks 18 in the longitudinal direction Z is allowed, since the locking blocks 18 abut against an abutting surface 91 of the coupling portion 9, as best visible in FIGS. 8, 9, 11 and 12. The locking blocks 18 are only allowed to move along a horizontal direction pushed by the effect of the component F₂₂ of the pushing force F2.

Therefore, the locking blocks 18, as a result of the pushing force F2 exerted by the pushing surface 16 are gradually inserted inside the holes 12 which are provided in the surface of the sleeve 10 until they reach the locking configuration Y shown in FIG. 2, in which the locking blocks 18 are inserted in the groove 25 which is provided in the mouth 24 of the neck 23, thus locking the column 6 in the sleeve 10.

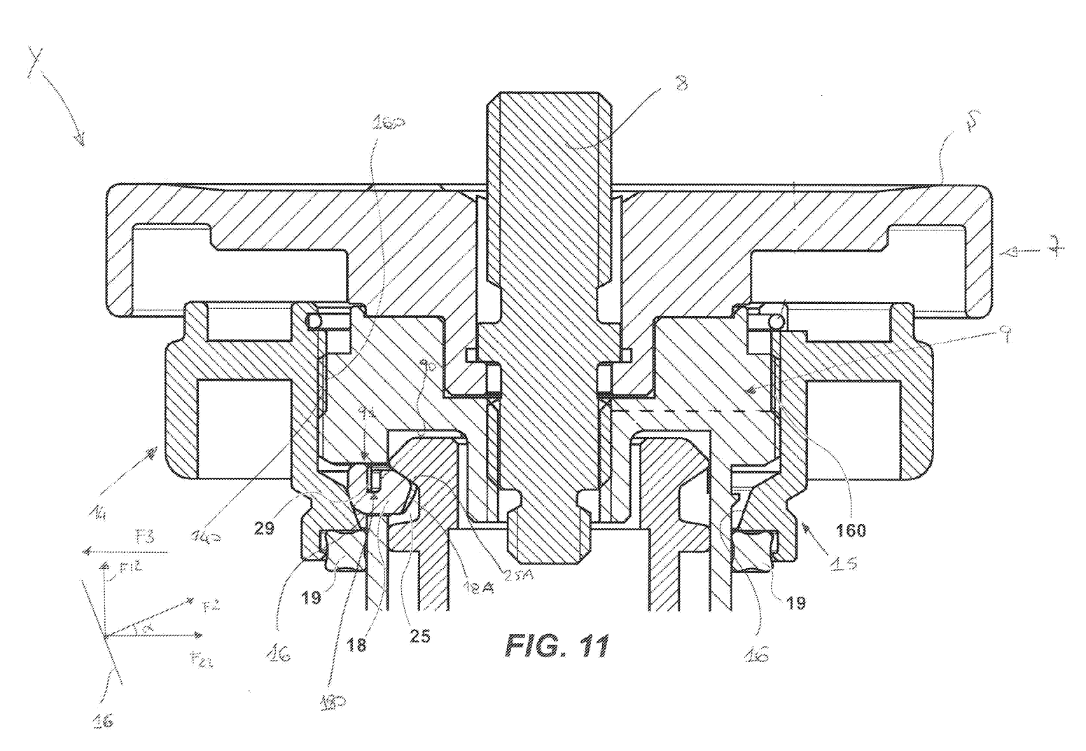

When the locking blocks 18 are progressively introduced into the grove 25, a pushing wall 18a of the blocks 18 interacts with a wall 25a of the groove 25 which is directed towards the resting plate 70, better visible in FIGS. 11, 12 and 13 gradually urging the neck 23 towards the resting plate 70.

The neck 23 is moved in the direction indicated by the arrow F in FIG. 2, i.e. further towards the resting plate 70, and the sleeve 10 is further fitted on the neck 23 itself until the free edge 10C of the sleeve moves into abutment against the shoulder 23C.

In that position, the surface 26 and the free edge 10C are connected in a positive-locking manner and the neck 23 is further clamped to the sleeve 10.

In the operative configuration W of FIG. 2, therefore, the column 6, i.e. neck 23 and the plate 7, i.e. the sleeve 10 are mutually connected in two separate longitudinally opposing positions with respect to the axis Z, by the locking blocks 18 inserted in the groove 25 at the mouth 24 and by the positive coupling between the surface 26 and the free edge 10C at the shoulder 23C.

During the positioning of the tripod 1 in the operative configuration W, the optional presence of the apparatus fixed to the resting plate 70 would not constitute impediments to the locking between the column 6 and the plate 7, therefore the apparatus may be readily fixed to the resting plate 70 equally well before and after it is engaged with the column 6.

In order to adjust the height of the resting plate 70, i.e. the height at which the video-photographic apparatus is positioned, the user moves the column 6 in the hole 5 along the longitudinal axis Z until it reaches the desired position, or the height desired for the resting plate 70 and therefore for the apparatus engaged therewith, and then locks the column 6 or the sleeve 10 in the desired position in the hole 5 by the clamp ring 20.

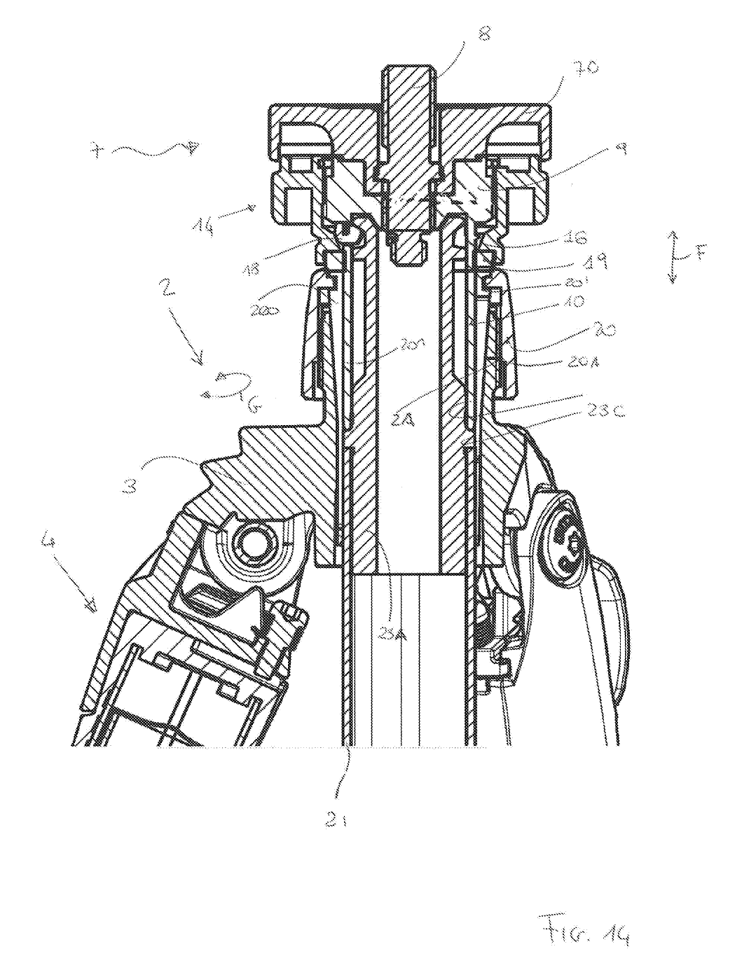

When the user desires to position the plate 7 at a very limited height, the user moves the column 6 until the sleeve 10 is positioned into the hole 5, as shown in FIG. 14.

The plate 7 can be slid into the hole until the gasket 19 abuts on the clamp ring 20, as visible in FIGS. 6 and 14.

By rotating the clamp ring, the column 6 or the sleeve are clamped into the hole 5 at the desired height.

The clamp ring 20 is arranged to be rotated about the longitudinal axis Z for clamping/releasing the column 6 or the sleeve 10 to/from the cross-member 2.

The clamp ring 20 is provided with a thread 20A cooperating with a further thread 2A provided on the cross member 2 so that the clamp ring 20 may be rotated about the cross member 2.

The clamp ring 20 is rotatable in both directions of the arrow G′ in FIG. 1, by a user of the tripod in order to lock/unlock the column 6 or the sleeve 10 into/from the legs 4.

Rotating the clamp ring 20 the latter is also moved along the longitudinal axis Z up and down, i.e. away from or towards the legs 4.

By rotating the clamp ring 20, the protrusion 20′ slide into the recess 202 correspondingly pushing the fitting cone 200 up and down, i.e. away from or towards the legs 4.

Since the internal surface 201 of the fitting cone 200 is tapered along the longitudinal axis Z by moving it along the longitudinal axis causes a change in the clamping action exerted by the internal surface of the fitting cone 200 on the column 6 or the sleeve 10.

Therefore, since the internal surface 201 has frusto-conical shape moving the fitting cone 200 along the longitudinal axis Z it is possible to clamp the column 6 or the sleeve 10 into the hole 5 or to release the column 6 or the sleeve 10 form the hole 5 so that the column 6 or the sleeve 10 may be slid along the longitudinal axis Z.

By rotating the clamp ring 20 so as to move the latter down, the fitting cone 200 is pushed down and pressed against the column 6 or the sleeve 10 thus clamping the column 6 or the sleeve 10 in the hole 5.

If the user wishes to photograph subjects which are positioned very near the ground and to prevent a spatial requirement of the column 6 which would not allow the apparatus to be positioned as desired, he makes provision for the tripod 1 to be positioned in the second operating position W″ shown in FIG. 6 in which the sleeve 10 is inserted in the hole 5 and the column 6 is not connected to the sleeve 10.

In order to do this, the user provides for unlocking the plate 7 from the column 6 by acting on the locking nut 14 so as to move it away with respect to the resting plate 70, moving it in the direction indicated by the arrow F1 in FIG. 2 so as to move the tripod 1 into the intermediate configuration of FIG. 3.

The pushing surface 16 is moved away from the resting plate 70, the locking blocks 18 are moved out from the groove 25 and the holes 12 being pushed by the flat springs 29, by sliding on the pushing surface 16 and progressively being introduced into the housing 27 provided between the locking nut 14 and the sleeve 10.

When the locking blocks 18 are in the retracted position X shown in FIG. 3, the neck 23 is no longer pressed into abutment against the coupling portion 9, therefore the connection surface 26 does not interfere with the internal surface 10b of the sleeve 10.

With the locking blocks 18 in the retracted position X, therefore, the column 6 is free to slide in the sleeve 10 and may be freely uncoupled from the sleeve 10 in order to uncouple the plate 7 and the column 6.

After disconnecting the plate 7 and the column 6, the user provides for disengaging the column 6 from the hole 5 by unlocking it by the clamp ring 20 and withdrawing the column 6 from the hole 5.

The user may optionally initially withdraw the column 6 which is engaged with the plate 7 from the hole 5 and subsequently act on the locking device 13 in order to uncouple the plate 7 and the column 6.

The user then inserts the sleeve 10, without the column 6, in the hole 5 until the gasket 19 is moved into abutment against the clamp ring 20 and, by acting on the clamp ring 20 itself, locks the sleeve 10 in the hole 5, positioning the tripod in the second operative configuration W″ of FIG. 6.

In this case in the same manner discussed above, by acting on the clamp ring 20 the fitting cone is actuated for clamping releasing the sleeve 10.

In this position the tubular cylindrical body of the sleeve 10 is at least partly inserted into the hole 5 so as to interact with the clamp ring 20 so that the sleeve 10 may be clamped into the hole 5.

Since the sleeve 10 has an outer diameter D1″ which is substantially equivalent to the outer diameter D1 of the shaft 21 of the column 6, the locking of the support both in the second operative configuration W″ and in the first operative configuration W is stable.

In order to lock the sleeve 10 into the hole 5 of the cross-member 2, the user will act on the clamp ring 20, in a manner known in the field.

The user will rotate the clamp ring 20 about the longitudinal axis Z so as to gradually fitting the internal surface 201 of the fitting cone 200 on the sleeve 10 so as to gradually clamp the sleeve 10 into the hole 5.

Moreover since the outer diameter D1″ of the sleeve 10 and the outer diameter D1 of the shaft 21 are substantially reciprocally equivalent, it is possible to obtain an effective clamping in both the first and the second operative configuration W, W″.

The movement between the configurations of the tripod 1 shown in FIGS. 2 and 6, respectively, may be carried out without any need for separating the apparatus from the resting plate 70.

Therefore, possible damage to the video-photographic apparatus is prevented and the operations for converting the tripod 1 are speeded up, and the positioning operations are substantially simplified. FIG. 14 is a broken-away and partially sectioned front view of the support according to the invention in a further operative configuration W. In FIG. 14, the plate 7 is similar to the plate shown in FIG. 3.

Therefore, the present invention solves the problems set out above with regard to the art.

1. A support for video-photographic apparatuses comprising:
a cross-member, which defines a hole,
a column having a shaft, which is slidable in the hole along a longitudinal axis,
a plate, which is provided with an engaging device for engaging a piece of video-photographic apparatus with said plate, and
a sleeve, which is internally hollow, which extends along the longitudinal axis and which is capable of receiving an engaging portion of said column,
said cross-member comprising a clamp element for clamping said column on said cross-member,
further comprising a locking device for removably locking said engaging portion of said column to said sleeve, wherein said sleeve comprises a tubular cylindrical body extending along said longitudinal axis having an outer diameter that is substantially equivalent to an outer diameter of said shaft, the column being configured to be inserted in said hole and to engage said clamping element for clamping said sleeve on said cross-member,
wherein said locking device comprises fixing elements of said plate, and wherein said locking device comprises a locking ring nut that is rotatable about said longitudinal axis of said sleeve, and which is translatable towards/away from said plate as a result of said rotation about the longitudinal axis, to move said fixing elements from a retracted position to a locking position and vice versa;
wherein said locking ring nut comprises a pushing surface, which is inclined through an inclination angle with respect to said longitudinal axis, and which is formed so as to receive in abutment said fixing elements to move said fixing elements between said retracted position and said locking position; and
wherein the engaging portion of said column is configured to be inserted in the sleeve for an extent between a free end of the engaging portion and a shoulder of the engaging portion and being engaged in the sleeve at both the free end and the shoulder of the engaging portion.

2. The support according to claim 1, wherein said fixing elements are movable between the retracted position in which said fixing elements are positioned inside a housing and said engaging portion is movable in said sleeve, and the locking position in which said fixing elements cooperate with a counter locking element which are provided on said engaging portion to lock said column in said sleeve.

3. The support according to claim 2, wherein said fixing elements are a plurality of sliding blocks which are arranged in a circumferentially spaced-apart position in said sleeve, and which are capable of being slidingly received in corresponding holes of a plurality of holes provided in said sleeve to cooperate with said counter locking element to lock said column in said sleeve.

4. The support according to claim 3, wherein said plurality of sliding blocks comprise three sliding blocks positioned in a circumferentially spaced-apart position in said sleeve.

5. The support according to claim 3, wherein said counter locking element comprises a groove element which is provided to receive said plurality of sliding blocks in said locking position to lock said column in said sleeve.

6. The support according to claim 1, wherein said pushing surface is inclined through the angle with respect to said longitudinal axis between 15° and 30°.

7. The support according to claim 2, wherein said locking device comprises a pushing device to push said fixing elements into the housing.

8. The support according to claim 2, wherein said locking device further comprises a coupling device which is provided on said sleeve in a longitudinally opposite position with respect to said fixing elements and which are arranged to cooperate with corresponding counter coupling device which is provided on said engaging portion in a longitudinally opposite position with respect to the counter locking element and which is provided to lock said column in said sleeve.

9. The support according to claim 1, wherein said shaft is shaped as to be slidable inside said hole and provided at a longitudinal end thereof with the engaging portion capable of being inserted in said sleeve to connect said column to said plate.

10. The support according to claim 9, wherein said engaging portion comprises a first portion which is positionable inside said shaft, a second portion which is capable of being inserted in a sliding manner inside said sleeve and a shoulder which is interposed between said first portion and said second portion capable of acting as a travel limit element during insertion of said engaging portion in said sleeve.

11. The support according to claim 1, wherein said sleeve and said shaft have respective outer diameters which are substantially equivalent so that when said column is fixed in said sleeve a substantial continuous surface is formed along said longitudinal axis which is slidable along said longitudinal axis of said hole.

12. A support for video-photographic apparatuses comprising:
a cross-member, which defines a hole,
a column having a shaft, which is slidable in the hole along a longitudinal axis,
a plate, which is provided with an engaging device for engaging a piece of video-photographic apparatus with said plate, and
a sleeve, which is internally hollow, which extends along the longitudinal axis and which is capable of receiving an engaging portion of said column,
said cross-member comprising a clamp element for clamping said column on said cross-member,
further comprising a locking device for removably locking said engaging portion of said column to said sleeve, wherein said sleeve comprises a tubular cylindrical body extending along said longitudinal axis having an outer diameter that is substantially equivalent to an outer diameter of said shaft, the column being configured to be inserted in said hole and to engage said clamping element for clamping said sleeve on said cross-member,
an engaging portion of the shaft being configured to be inserted in the sleeve between a free end and a shoulder of said shaft, and being engaged in the sleeve at both the free end and the shoulder.

13. The support according to claim 12, wherein the shoulder is configured such that it acts as a travel limiting element during the insertion of the engaging portion in the sleeve.

14. The support according to claim 12, wherein said locking device comprises fixing elements for fixing said plate which are movable between a retracted position in which said fixing elements are positioned inside a housing and said engaging portion is movable in said sleeve, and a locking position in which said fixing elements cooperate with a counter locking element which are provided on said engaging portion to lock said column in said sleeve.

15. The support according to claim 14, wherein said locking device comprises a plurality of sliding blocks which are arranged in a circumferentially spaced-apart position in said sleeve, and which are capable of being slidingly received in corresponding holes of a plurality of holes provided in said sleeve to cooperate with said counter locking element to lock said column in said sleeve.

16. The support according to claim 14, wherein said locking device comprises a pushing device to push said fixing elements into the housing.

17. The support according to claim 14, wherein said locking device further comprises a coupling device which is provided on said sleeve in a longitudinally opposite position with respect to said fixing elements and which is arranged to cooperate with corresponding counter coupling device which is provided on said engaging portion in a longitudinally opposite position with respect to counter locking element and which is provided to lock said column in said sleeve.

18. The support according to claim 12, wherein said locking device comprises a locking ring nut which is rotatable about said longitudinal axis of said sleeve and which is translatable towards/away from said plate as a result of rotation about the longitudinal axis to move said fixing elements from a retracted position to a locking position and vice versa; and
wherein said locking ring nut comprises a pushing surface which is inclined through an inclination angle with respect to said longitudinal axis and which is formed so as to receive in abutment said fixing elements to move said fixing elements between said retracted position and said locking position.

19. The support according to claim 1, wherein the shoulder acts as a travel limit element during insertion of the engaging portion in the sleeve.
